(19) United States
(12) Patent Application Publication
(10) Pub. No.: US 2009/0299595 A1
(43) Pub. Date: Dec. 3, 2009

(54) Driving evaluating apparatus, driving evaluating method, and computer program for driving evaluation

(75) Inventors: Satoshi Harumoto, Kobe-shi (JP); Kouei Kiyo, Kobe-shi (JP)

Correspondence Address: OLIFF & BERRIDGE, PLC, P.O. BOX 320850, ALEXANDRIA, VA, 22320-4850, US

(73) Assignee: FUJITSU TEN LIMITED, Kobe-shi (JP)

(21) Appl. No.: 12/453,774

(22) Filed: May 21, 2009

(30) Foreign Application Priority Data
May 30, 2008 (JP) 2008-143043

(51) Int. Cl. G06F 19/00

(52) U.S. Cl. 701/70

(57) ABSTRACT

In a driving evaluating apparatus, a first unit detects a stable acceleration area that is an area in which an accelerator opening rate fluctuates within a predetermined range, a second unit detects a vehicle speed slowdown area that is an area in which a vehicle speed is decreased according to a reference speed obtained from the vehicle speed in the stable acceleration area and to an actual vehicle speed representing an actual speed of a vehicle, a third unit detects a recovering acceleration area that is an area in which an excessive recovering acceleration is performed according to a reference accelerator opening rate corresponding to a start point of the vehicle speed slowdown area and to an actual accelerator opening rate representing an actual value of the accelerator opening rate, and a judging unit judges whether the accelerator operation is appropriate according to the recovering acceleration area.

### CROSS-REFERENCE TO RELATED APPLICATION

This application is based upon and claims the benefit of priority of the prior Japanese Patent Application No. 2008-143043, filed on May 30, 2008, the entire contents of which are incorporated herein by reference.

### BACKGROUND OF THE INVENTION

1. Field of the Invention

The present invention relates to a driving evaluating apparatus, a driving evaluation method and a driving evaluation program for evaluating fuel-saving driving of a vehicle, and relates in particular to a driving evaluating apparatus, a driving evaluation method and a driving evaluation program that can be used widely for various types of automobiles having different performances, and can evaluate driving quantitatively about ecological driving.

2. Description of the Related Art

In recent years, environment-friendly fuel-saving driving (ecological driving or so-called eco-driving) has been asked for in driving of a vehicle such as an automobile, in view of global environment. For example, driving with repetition of abrupt acceleration and abrupt deceleration consumes a large amount of fuel, and increases an amount of exhaust gas; therefore, such driving is not favorable in terms of ecological driving.

In one technique, in response to enhanced ecological driving awareness, a driver is informed of whether the driving state corresponds to ecological driving. For example, Japanese Patent Application Laid-open No. 2007-22505 discloses a technique of acquiring a state of acceleration/deceleration based on a vehicle speed, and displaying for a driver points of driving evaluation from which several points are subtracted in cases of abrupt acceleration or abrupt deceleration, which are against ecological driving.

However, in the technique disclosed in Japanese Patent Application Laid-open No. 2007-22505, merely an abstract driving state against ecological driving is defined, and a specific evaluation approach for ecological driving is not presented. Accordingly, the technique of Japanese Patent Application Laid-open No. 2007-22505 has a problem that quantitative evaluation of whether the driving state is ecological driving is not possible.

Although some automobiles evaluate driving based on a fuel consumption rate of their own, the fuel consumption rate is usually different for types of automobiles, and displacements of engines, for example. Accordingly, the approach of evaluating ecological driving based on a fuel consumption rate is not a versatile approach.

### SUMMARY OF THE INVENTION

It is an object of the present invention to at least partially solve the problems in the conventional technology.

According to an aspect of an embodiment of the present invention, a driving evaluating apparatus that evaluates fuel-saving driving of a vehicle, includes a stable acceleration area detecting unit that detects a stable acceleration area that is an area in which an accelerator opening rate fluctuates within a predetermined range; a vehicle speed slowdown area detecting unit that detects a vehicle speed slowdown area that is an area in which a vehicle speed is decreased according to a reference vehicle speed obtained by calculating based on the vehicle speed in the stable acceleration area detected by the stable acceleration area detecting unit and to an actual vehicle speed that represents an actual value of the vehicle speed; a recovering acceleration area detecting unit that detects a recovering acceleration area that is an area in which a recovering acceleration is excessively performed according to a reference accelerator opening rate corresponding to a start point of the vehicle speed slowdown area detected by the vehicle speed slowdown area detecting unit and to an actual accelerator opening rate that represents an actual value of the accelerator opening rate; and an accelerator operation judging unit that judges whether an accelerator operation is appropriate according to the recovering acceleration area detected by the recovering acceleration area detecting unit.

According to another aspect of an embodiment of the present invention, a method for evaluating fuel-saving driving of a vehicle, includes detecting a stable acceleration area that is an area in which an accelerator opening rate fluctuates within a predetermined range; detecting a vehicle speed slowdown area that is an area in which a vehicle speed is decreased according to a reference vehicle speed obtained by calculating based on the vehicle speed in the detected stable acceleration area and to an actual vehicle speed that represents an actual value of the vehicle speed; detecting a recovering acceleration area that is an area in which a recovering acceleration is excessively performed according to a reference accelerator opening rate corresponding to a start point of the detected vehicle speed slowdown area and to an actual accelerator opening rate that represents an actual value of the accelerator opening rate; and judging whether an accelerator operation is appropriate according to the detected recovering acceleration area.

According to still another aspect of an embodiment of the present invention, a computer readable storage medium stores therein a computer program that implements the above method on a computer.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic of a driving evaluation method according to the present invention;

FIG. 2 is a schematic of a configuration of a driving evaluating apparatus according to an embodiment;

FIG. 3 is a schematic of a driving status detecting processing performed by a control unit;

FIG. 4 is a schematic of a first outline of an acceleration stable area detecting processing;

FIG. 5 is a schematic of a second outline of the acceleration stable area detecting processing;

FIG. 6 is a schematic of an update timing of a stable acceleration flag;

FIG. 7 is a schematic for explaining how to obtain a speed slowdown reference vehicle speed;

FIG. 8 is a schematic for explaining an update timing of a vehicle speed slowdown judging flag;

FIG. 9 is a schematic for explaining how to obtain a reference accelerator opening rate used in a recovering acceleration area detecting processing;

FIG. 10 is a schematic for explaining a first update timing of a recovering acceleration judging flag;

FIG. 11 is a schematic for explaining a second update timing of a recovering acceleration judging flag;

FIG. 12 is a schematic for explaining an update timing of a vehicle speed fluctuation flag; and

FIG. 13 is a flowchart of the procedure executed by the driving evaluating apparatus.

### DETAILED DESCRIPTION OF THE PREFERRED EMBODIMENTS

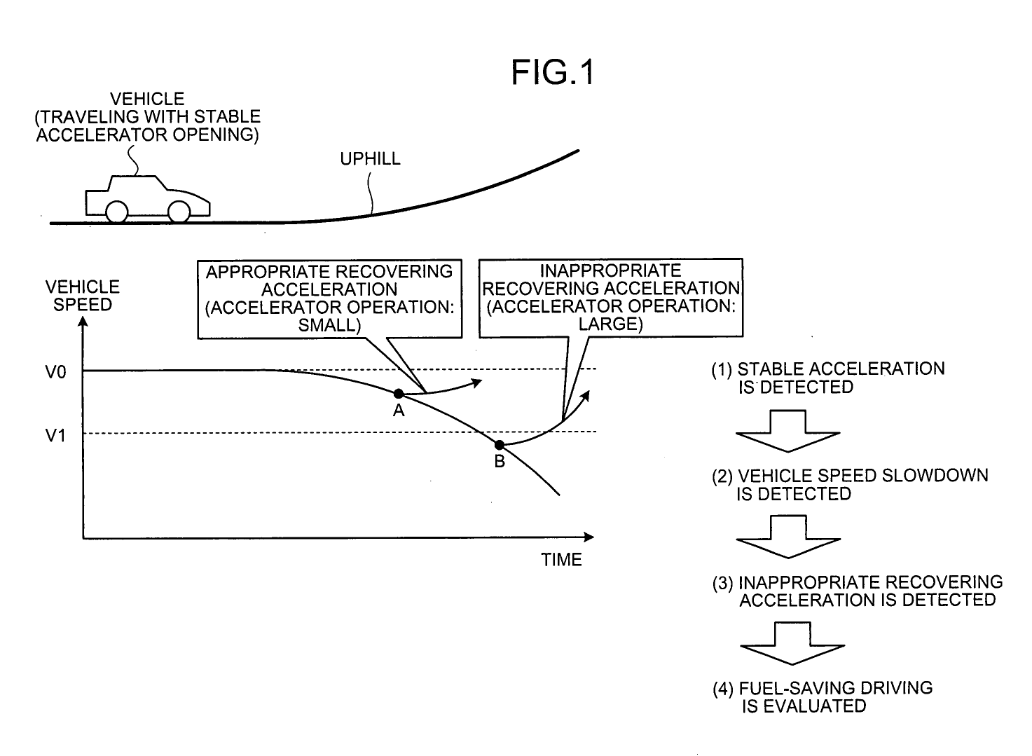

Exemplary embodiments of a driving evaluating apparatus, a driving evaluation method and a driving evaluation program according to the present invention are described below in greater detail with reference to the accompanying drawings. First, in the following, an outline of the driving evaluation method according to the present invention is explained with reference to FIG. 1, and then an embodiment of the driving evaluating apparatus to which the driving evaluation method is applied is explained.

An outline of the driving evaluation method according to the present invention is explained with reference to FIG. 1. FIG. 1 is a schematic of the driving evaluation method according to the present invention. Here, “V0” depicted in FIG. 1 represents a vehicle speed of a vehicle traveling with a stable accelerator opening, and “V1” in FIG. 1 represents a vehicle speed obtained by subtracting a predetermined threshold from “V0”. The vehicle speed is used for detecting a vehicle speed slowdown of the vehicle.

As depicted in FIG. 1, in the driving evaluation method according to the present invention, evaluation is performed about ecological driving in a situation in which a vehicle traveling with a stable accelerator opening (for example, traveling on an expressway) gradually slows down upon entering an uphill.

The driving evaluation method according to the present invention is based on an idea that, in the above described situation for example, it is judged that driving is a fuel-saving drive when the driver of the vehicle quickly notices the slowdown of the vehicle due to the uphill, and performs a recovering acceleration, that is, an acceleration to recover the original vehicle speed, with a minimal amount of accelerator operation.

More specifically, it is judged that an appropriate recovering acceleration is performed when the driver presses down the accelerator before the vehicle speed decreases to “V1” (see A in FIG. 1). This is because, when the vehicle speed is slightly decreased, only a small amount of pressing down the accelerator is required to recover the original vehicle speed.

On the other hand, it is judged that an inappropriate recovering acceleration is performed when the driver presses down the accelerator after the vehicle speed falls below “V1” (see B in FIG. 1). This is because larger amount of pressing down the accelerator is required for recovering the original vehicle speed if the amount of vehicle speed slowdown is larger. A large amount of pressing down the accelerator degrades fuel efficiency and thus, is not favorable from the viewpoint of fuel-saving driving.

Thus, in the driving evaluation method according to the present invention, vehicle speed slowdown is detected while a vehicle is traveling in a stable acceleration driving and then, whether the fuel-saving driving is appropriately performed is judged according to whether a recovering acceleration depending on acceleration operation is appropriate.

More specifically, in the driving evaluation method according to the present invention, a stable acceleration driving is detected (see (1) in FIG. 1). When a predetermined amount of vehicle speed slowdown is detected while the vehicle is traveling in the stable acceleration driving (see (2) in FIG. 1), an inappropriate recovering acceleration is detected based on a predetermined judging condition (see (3) in FIG. 1). Then, fuel-saving driving is evaluated based on the detection result of the recovering acceleration (see (4) in FIG. 1).

That is, because fuel-saving driving is evaluated based on versatile data such as accelerator operation (an accelerator opening rate) and a vehicle speed, the driving evaluation method according to the present invention can be used widely for various automobiles having different performances. By using the detection condition of stable acceleration driving, a detection condition of vehicle speed slowdown, and a detection condition of inappropriate recovering acceleration, ecological driving can be evaluated quantitatively.

In the following, an embodiment of the driving evaluating apparatus to which the above driving evaluation method is applied is explained. Although a driving evaluating apparatus mounted on a vehicle such as an automobile is explained in the following embodiment, the driving evaluating apparatus may be configured on a server apparatus provided on a network with which a vehicle can communicate.

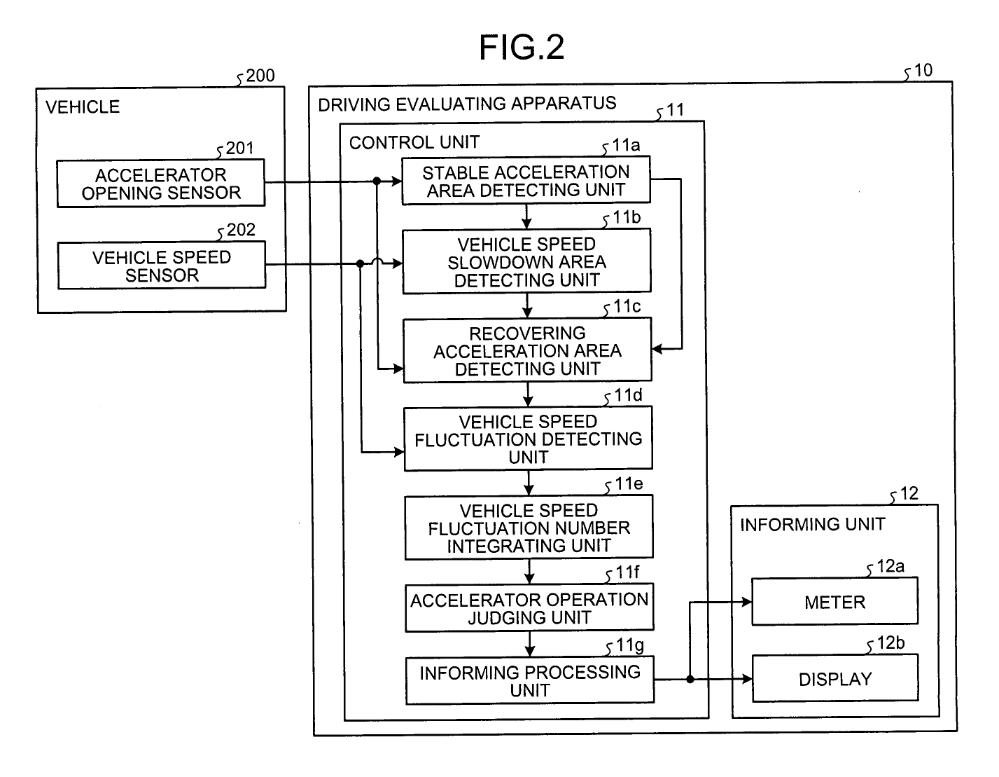

FIG. 2 is a schematic of a configuration of a driving evaluating apparatus 10 according to the present embodiment. The driving evaluating apparatus 10 acquires an accelerator opening rate and a vehicle speed, respectively, from an accelerator opening rate sensor 201 and a vehicle speed sensor 202 of a vehicle 200. The driving evaluating apparatus 10 may acquire sensor values from the vehicle sensors through an engine control unit (ECU) of the vehicle 100. In FIG. 2, the driving evaluating apparatus 10 includes an informing unit 12 having a meter 12a and a display 12b. However, the driving evaluating apparatus 10 may be configured to exclude the informing unit 12.

As depicted in FIG. 2, the driving evaluating apparatus 10 includes a control unit 11 and the informing unit 12. The control unit 11 includes a stable acceleration area detecting unit 11a, a vehicle speed slowdown area detecting unit 11b, a recovering acceleration area detecting unit 11c, a vehicle speed fluctuation detecting unit 11d, a vehicle speed fluctuation number integrating unit 11e, an accelerator operation judging unit 11f, and an informing processing unit 11g. The informing unit 12 includes the meter 12a and the display 12b.

The control unit 11 performs driving status detecting processing such as detecting of a stable acceleration area, a vehicle speed slowdown area in the stable acceleration area, a recovering acceleration area after the vehicle speed is decreased, and a vehicle speed fluctuation after the recovering acceleration according to signal values provided by the vehicle sensors mounted on a vehicle 200, and then, performs an accelerator operation judgment based on the detection results. The control unit 11 also informs the informing unit 12 of the judgment result thus obtained.

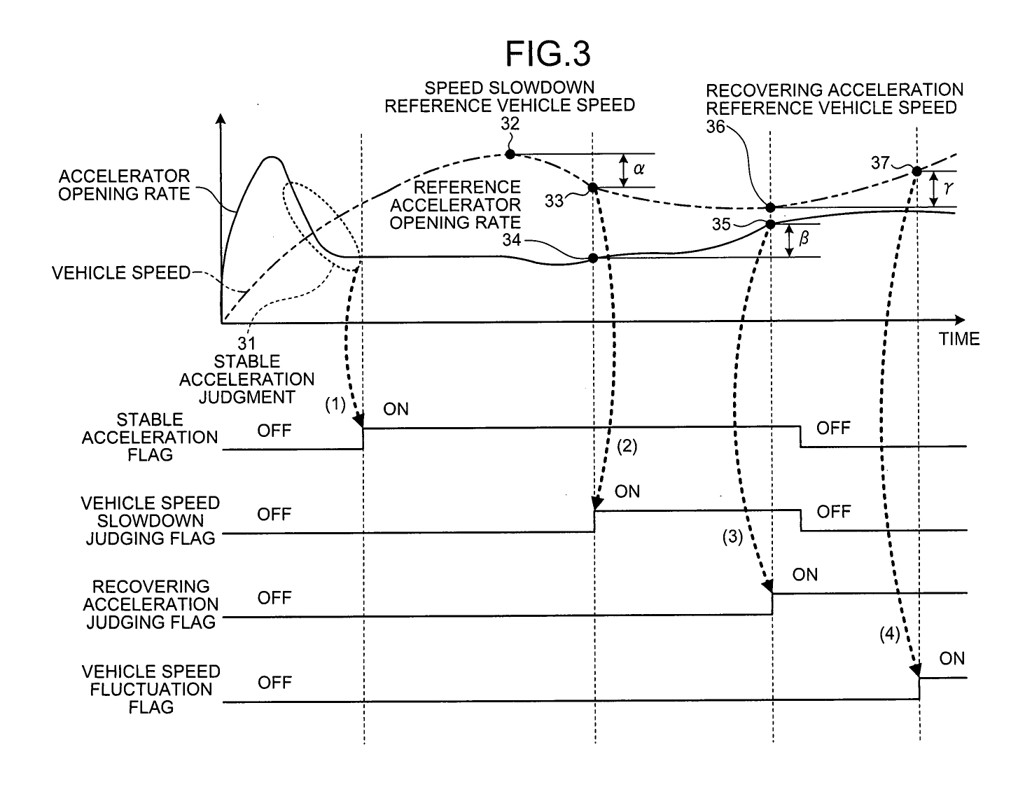

An outline of driving status detecting processing performed by the control unit 11 is described in greater detail below with reference to FIG. 3. FIG. 3 is a schematic of a driving status detecting processing performed by the control unit 11. A chart of time change of an accelerator opening rate and vehicle speed as well as judging flags (the stable acceleration flag, the vehicle speed slowdown judging flag, the recovering acceleration judging flag, and the vehicle speed fluctuation flag) that are ON/OFF controlled according to the accelerator opening rate or the vehicle speed are depicted in FIG. 3.

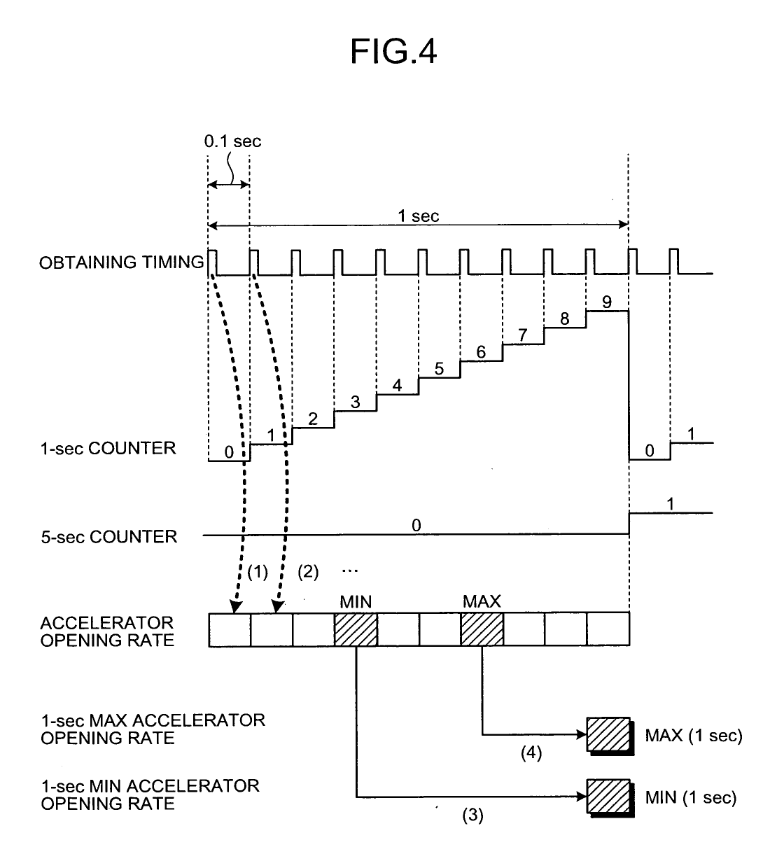

An outline of ON/OFF control of the stable acceleration flag in FIG. 3 is described in greater detail below. Stable acceleration judgment is performed according to the accelerator opening rate (see 31 in FIG. 3), and then, the stable acceleration flag is turned ON when it is judged that the accelerator is stably pressed down (see (1) in FIG. 3). The stable acceleration area detecting processing including a timing at which the stable acceleration flag is turned OFF is described later in greater detail with reference to FIGS. 4 to 6. The stable acceleration area detecting unit 11a performs the stable acceleration area detecting processing.

An outline of ON/OFF control of the vehicle speed slowdown judging flag in FIG. 3 is described below in greater detail. While the stable acceleration flag is turned ON, a speed slowdown reference vehicle speed used in the vehicle speed slowdown area detecting processing is determined (see 32 in FIG. 3). When the vehicle slows down for a predetermined value “α” from the speed slowdown reference vehicle speed (see 33 in FIG. 3), vehicle speed slowdown is detected, and the vehicle speed slowdown judging flag is turned ON (see (2) in FIG. 3).

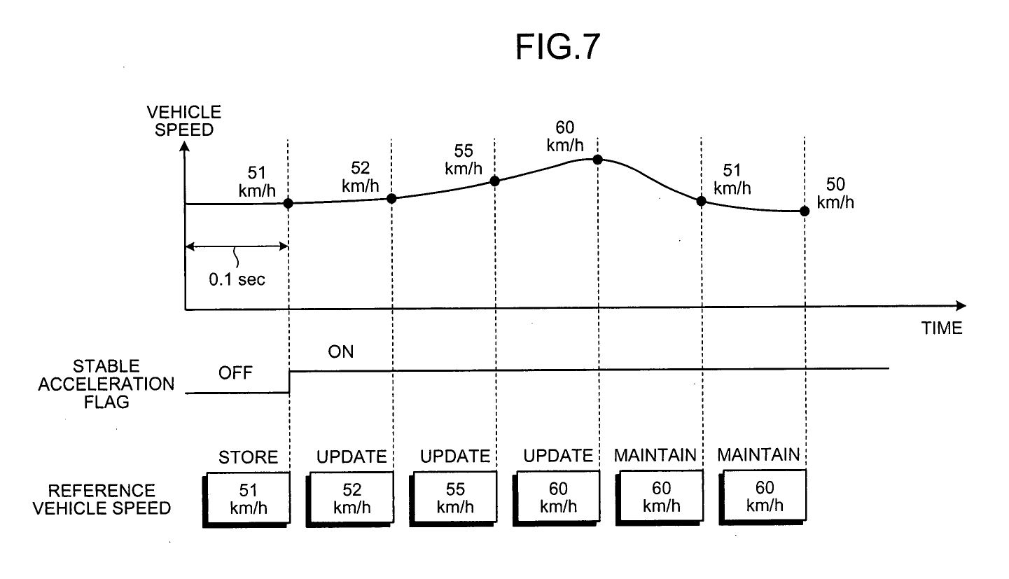

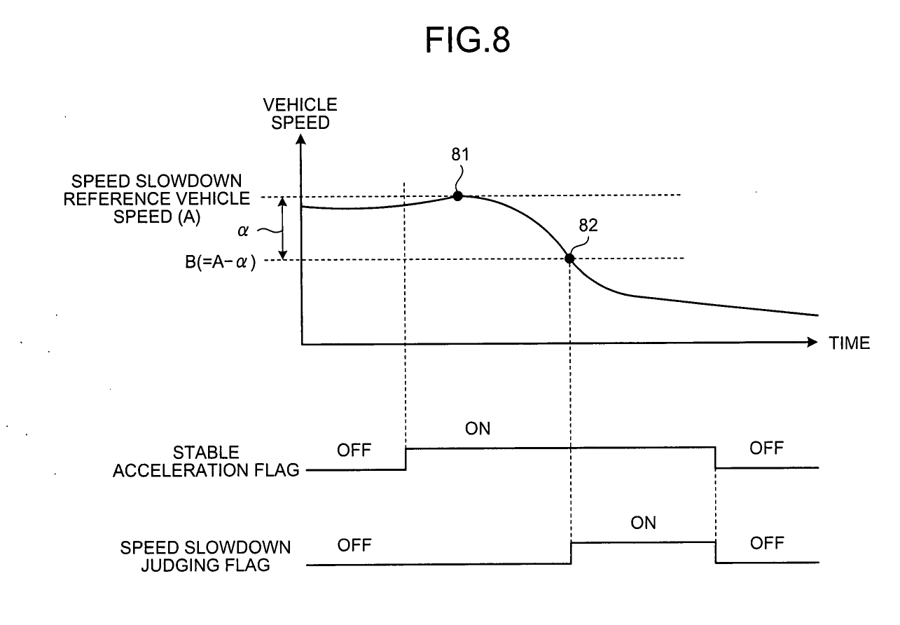

The vehicle speed slowdown judging flag and the stable acceleration flag are turned OFF simultaneously. The vehicle speed slowdown area detecting processing such as determination of the speed slowdown reference vehicle speed is described later in greater detail with reference to FIGS. 7 and 8. The vehicle speed slowdown area detecting unit 11b performs the vehicle speed slowdown area detecting processing.

An outline of ON/OFF control of the recovering acceleration judging flag in FIG. 3 is described below in greater detail. In the recovering acceleration area detecting processing, the reference accelerator opening rate at the time when the vehicle speed slowdown judging flag is turned ON is stored in the driving evaluating apparatus 10 as a reference accelerator opening rate (see 34 in FIG. 3). While the stable acceleration flag and the vehicle speed slowdown judging flag are both turned ON, it is judged that an inappropriate recovering acceleration is performed when an accelerator opening rate is increased for a predetermined value “β” from the reference accelerator opening rate stored in the driving evaluating apparatus 10 (see 35 in FIG. 3), the recovering acceleration judging flag is turned ON (see (3) in FIG. 3).

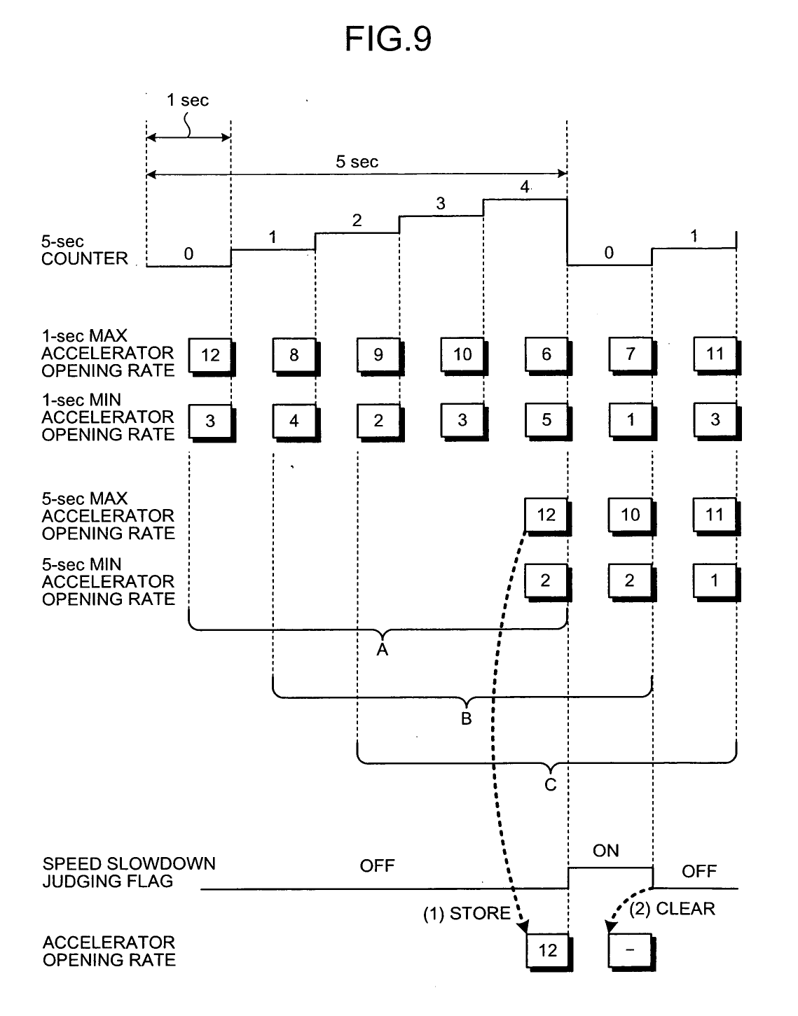

The recovering acceleration area detecting processing such as storing of the reference accelerator opening rate and a timing at which the recovering acceleration judging flag is turned OFF is described later in greater detail with reference to FIGS. 9 to 11. The recovering acceleration area detecting unit 11c performs the recovering acceleration area detecting processing.

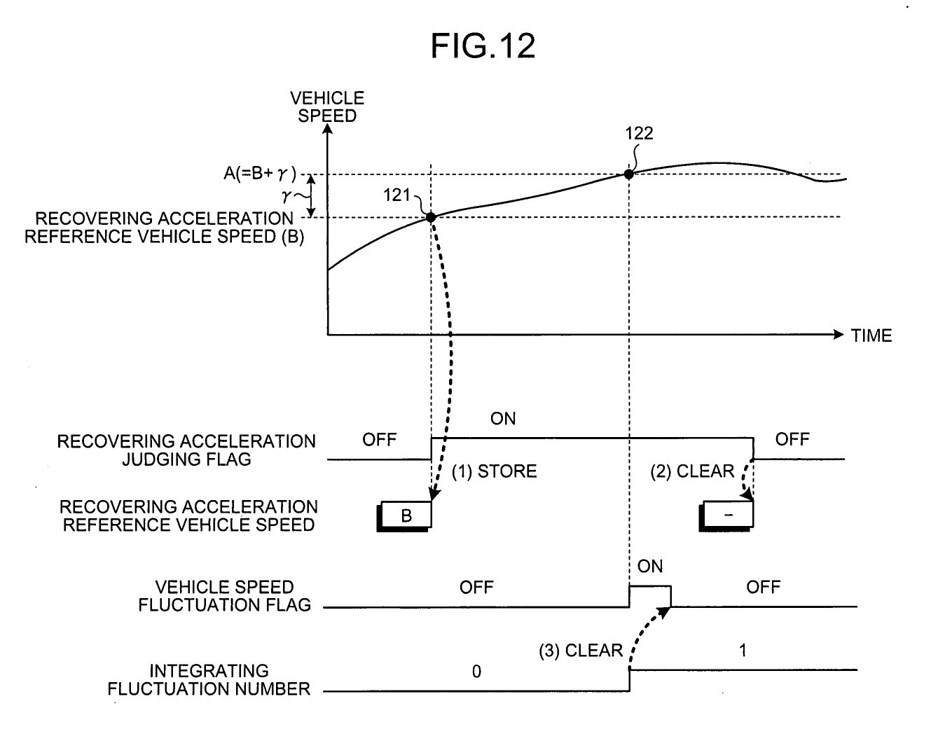

An outline of ON/OFF control of the vehicle speed fluctuation flag in FIG. 3 is described below in greater detail. In the vehicle speed fluctuation detecting processing, the vehicle speed at the time when the recovering acceleration judging flag is turned ON is stored in the driving evaluating apparatus 10 as a recovering acceleration reference vehicle speed (see 36 in FIG. 3). While the recovering acceleration judging flag is ON, it is judged that the vehicle speed is fluctuated due to recovering acceleration when the vehicle speed is increased for a predetermined value “γ” from the recovering acceleration reference vehicle speed stored in the driving evaluating apparatus 10 (see 37 in FIG. 3), and then, the vehicle speed fluctuation flag is turned ON (see (4) in FIG. 3). Vehicle speed fluctuation detecting processing is described later in greater detail with reference to FIG. 12. The vehicle speed fluctuation detecting unit 11d performs the vehicle speed fluctuation detecting processing.

Returning to the description of FIG. 2, the processing units included in the control unit 11 are described below in greater detail. The stable acceleration area detecting unit 11a judges whether the accelerator opening rate is within a predetermined fluctuation range according to a signal value provided by an accelerator opening sensor 201, and thus, detects an area in which the accelerator opening rate is stable, that is, a stable acceleration area. The stable acceleration area detecting unit 11a also informs the vehicle speed slowdown area detecting unit 11b and the recovering acceleration area detecting unit 11c of the detection result thus obtained.

The stable acceleration area detecting processing performed by the stable acceleration area detecting unit 11a is described below in greater detail with reference to FIGS. 4 to 6. FIG. 4 is a schematic of a first outline of the stable acceleration area detecting processing. In FIG. 4, the accelerator opening rate is obtained every 0.1 seconds, and the maximum value (MAX) and the minimum value (MIN) of the accelerator opening rate of the 1 second are obtained based on the obtained values.

A “1-sec counter” in FIG. 4 is a counter that is incremented by 1 every 0.1 seconds, and takes the value from 0 to 9. A “5-sec counter” in FIG. 4 is a counter that is incremented by 1 every second, and takes the value from 0 to 4.

As depicted in FIG. 4, the accelerator opening rate is obtained every 0.1 seconds. For example, the accelerator opening rate while the value of the 1-sec counter is 0 is stored in the first area of storage areas that consists of ten areas (see (1) in FIG. 4). Similarly, the accelerator opening rate while the value of the 1-sec counter is 1 is stored in the second area thereof (see (2) in FIG. 4). When the value of the 1-sec counter becomes nine, the values stored in the ten storage areas are compared with each other. Thus, the minimum value (MIN) and the maximum value (MAX) thereof are obtained.

For example, if the accelerator opening rate stored in the fourth area is the minimum value (MIN) and the accelerator opening rate stored in the seventh area is the maximum value (MAX), the “MIN” stored at the fourth area is selected as the smallest accelerator opening rate, that is, a 1-sec MIN accelerator opening rate during 1 second (see (3) in FIG. 4). Similarly, the “MAX” stored in the seventh area is selected as the largest accelerator opening rate, that is, a 1-sec MAX accelerator opening rate (see (4) in FIG. 4).

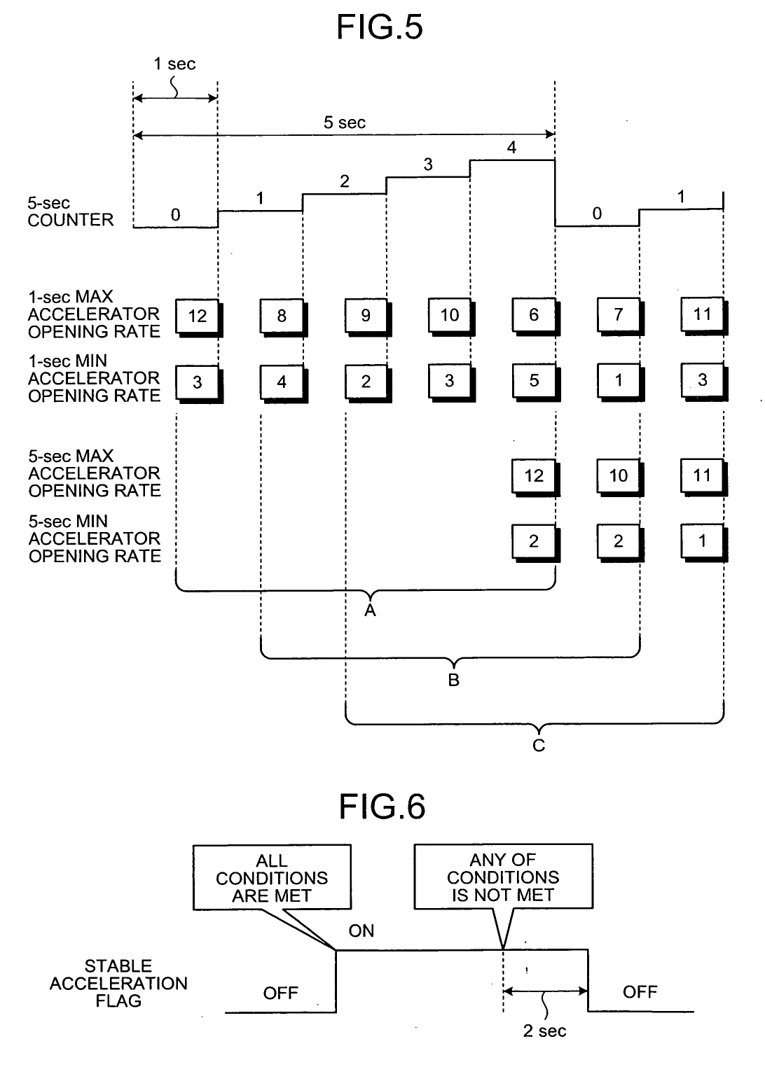

FIG. 5 is a schematic of a second outline of the stable acceleration area detecting processing. In FIG. 5, the MAX value of the most recent 5 seconds, that is, the 5-sec MAX accelerator opening rate, and the MIN value that of the most recent five seconds, that is, the 5-sec MIN accelerator opening rate, are obtained from the sets of 1-sec MAX accelerator opening rate and 1-sec MIN accelerator opening rate obtained in FIG. 4.

As depicted in FIG. 5, when the value of the 5-sec counter becomes 4, the largest value among the five 1-sec MAX accelerator opening rates in the most recent five seconds is obtained as the 5-sec MAX accelerator opening rate. Similarly, the smallest value among the five 1-sec MIN accelerator opening rates in the most recent 5 seconds is obtained as the 5-sec MIN accelerator opening rate.

For example, in a range A in FIG. 5, the largest 1-sec MAX accelerator opening rate is 12, and thus, the 5-sec MAX accelerator opening rate is 12. The smallest 1-sec MIN accelerator opening rate therein is 2, and thus, the 5-sec MIN accelerator opening rate therein is 2. In a range B in FIG. 5, the largest 1-sec MAX accelerator opening rate is 10, and thus, the 5-sec MAX accelerator opening rate is 10. The smallest 1-sec MIN accelerator opening rate therein is 2, and thus, the 5-sec MIN accelerator opening rate therein is 2. Similarly, in a range C in FIG. 5, the 5-sec MAX accelerator opening rate is 11 and the 5-sec MIN accelerator opening rate is 1.

FIG. 6 is a schematic depicting an update timing of the stable acceleration flag. The “conditions” in FIG. 6 includes three conditions of: (1) the vehicle speed is above a predetermined value (for example, 40 km/h); (2) the accelerator opening rate is above a predetermined value (for example, 10 percent); and (3) the difference between the MAX (maximum) accelerator opening rate and the MIN (minimum) accelerator opening rate during a predetermined period is smaller than a predetermined value. The conditions (1) and (2) are set for excluding traveling status such as traveling at low speed and traveling with the acceleration OFF from the subject of fuel-saving judgment. The predetermined value used in the condition (3) for evaluating the difference can be arbitrarily set.

As depicted in FIG. 6, when all the conditions, that is, the conditions (1) to (3), are met, the stable acceleration flag turns ON. When any of the conditions, that is, at least one of the conditions (1) to (3), is not met, the stable acceleration flag turns OFF after a grace period of 2 seconds. The grace period may be set to be other values.

Returning to the description of FIG. 2, the vehicle speed slowdown area detecting unit 11b is described below in greater detail. The vehicle speed slowdown area detecting unit 11b detects a vehicle speed slowdown that satisfies a predetermined condition according to a signal value provided by the vehicle speed sensor 202 when the stable acceleration area detecting unit 11a notifies the vehicle speed slowdown area detecting unit 11b that a start point of a stable acceleration area is detected. The vehicle speed slowdown area detecting unit 11b also notifies the recovering acceleration area detecting unit 11c of the detection result thus obtained.

The vehicle speed slowdown area detecting processing performed by the vehicle speed slowdown area detecting unit 11b is described below in greater detail with reference to FIGS. 7 and 8. FIG. 7 is a schematic for explaining how to obtain the speed slowdown reference vehicle speed. As depicted in FIG. 7, the vehicle speed slowdown area detecting unit 11b updates the reference vehicle speed stored in the driving evaluating apparatus 10 so that a reference vehicle speed is equal to the maximum vehicle speed while the stable acceleration flag is ON. Accordingly, the speed slowdown reference vehicle speed (the reference vehicle speed in FIG. 7) is the maximum vehicle speed while the stable acceleration flag is ON.

For example, as depicted in FIG. 7, 51 km/h is stored as the reference speed when the vehicle speed at the time when the stable acceleration flag is turned ON is 51 km/h. The reference speed is then updated to be 52 km/h, 55 km/h, and 60 km/h respectively as the vehicle speed is increased to 52 km/h, 55 km/h, and 60 km/h after each 0.1 seconds. On the other hand, the reference speed is maintained at 60 km/h even if the vehicle speed is decreased to 51 km/h or 50 km/h once the vehicle speed becomes 60 km/h.

FIG. 8 is a schematic for explaining the update timing of the vehicle speed slowdown judging flag. The speed slowdown reference vehicle speed (A) in FIG. 8 is obtained with the same procedure as in FIG. 7. That is, the speed slowdown reference vehicle speed (A) is the maximum vehicle speed after the stable acceleration flag is turned ON (see 81 in FIG. 8).

As depicted in FIG. 8, the value obtained by subtracting a predetermined value (α) from the speed slowdown reference vehicle speed (A) is B. The vehicle speed slowdown judging flag is turned ON when the vehicle speed is decreased to B (see 82 in FIG. 8). When the stable acceleration flag is turned OFF, the vehicle speed slowdown judging flag is also turned OFF. The predetermined value (α) may be arbitrarily set.

Returning to the description of FIG. 2, the recovering acceleration area detecting unit 11c is described below in greater detail. The recovering acceleration area detecting unit 11c detects that the accelerator opening rate is increased to be larger than a tolerable range, that is, that an inappropriate recovering acceleration is performed, according to a signal value provided by the accelerator opening sensor 201 when the vehicle is in both the acceleration stable area detected by the stable acceleration area detecting unit 11a and vehicle speed slowdown area detected by the vehicle speed slowdown area detecting unit 11b. The recovering acceleration area detecting unit 11c also notifies the vehicle speed fluctuation detecting unit 11d of the detection result.

The recovering acceleration area detecting processing performed by the recovering acceleration area detecting unit 11c is described below in greater detail with reference to FIGS. 9 to 11. FIG. 9 is a schematic for explaining how to obtain the reference accelerator opening rate used in the recovering acceleration area detecting processing. The characteristic of the 1-sec MAX accelerator opening rate, the 1-sec MIN accelerator opening rate, the 5-sec MAX accelerator opening rate, and the 5-sec MIN accelerator opening rate in FIG. 9 are similar to those in FIG. 5.

As depicted in FIG. 9, the 5-sec MAX accelerator opening rate at the timing at which the vehicle speed slowdown judging flag is turned ON is stored in the driving evaluating apparatus 10 as the reference accelerator opening rate (see (1), in FIG. 9). The reference accelerator opening rate stored therein is cleared (deleted) when the vehicle speed slowdown judging flag is turned OFF (see (2), in FIG. 9).

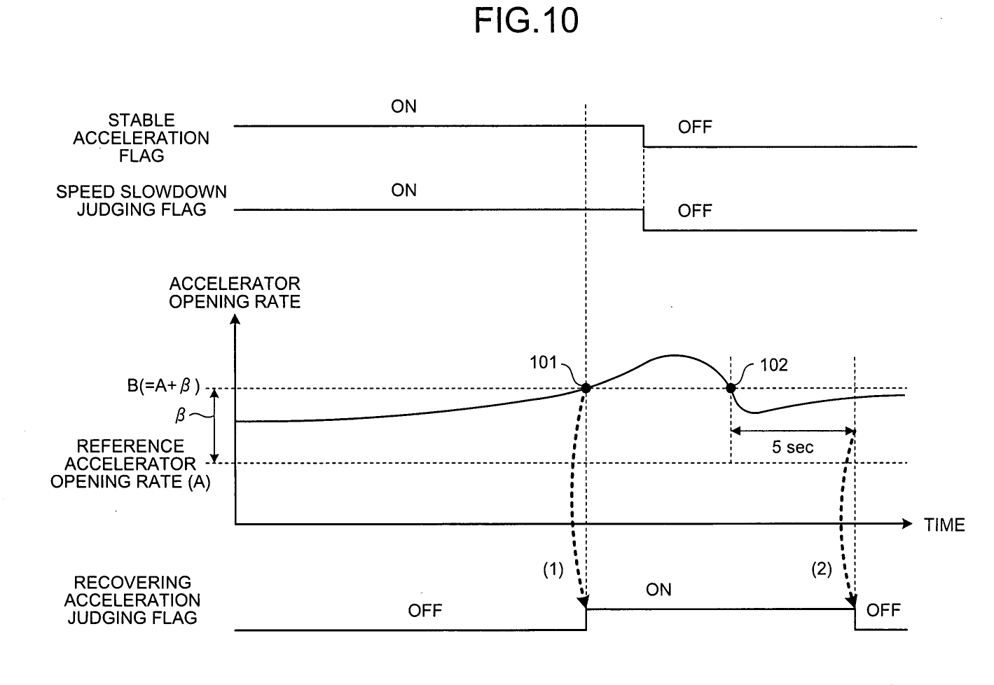

FIG. 10 is a schematic for explaining a first update timing of the recovering acceleration judging flag. The reference accelerator opening rate (A) depicted in FIG. 10 is the accelerator opening rate obtained according to the procedure depicted in FIG. 9. As depicted in FIG. 10, the recovering acceleration judging flag is turned ON while the stable acceleration flag and the vehicle speed slowdown judging flag are both ON.

As depicted in FIG. 10, the value obtained by adding a predetermined value (β) to the reference accelerator opening rate (A) is B. The recovering acceleration judging flag is turned ON (see (1) in FIG. 10) when the accelerator opening rate is increased to B (see 101 FIG. 10). The recovering acceleration judging flag is turned OFF after a grace period of 5 seconds (see (2) in FIG. 10) when the accelerator opening rate increased to be larger than B is decreased to B (see 102 in FIG. 10). The grace period and the predetermined value (β) may be arbitrarily set.

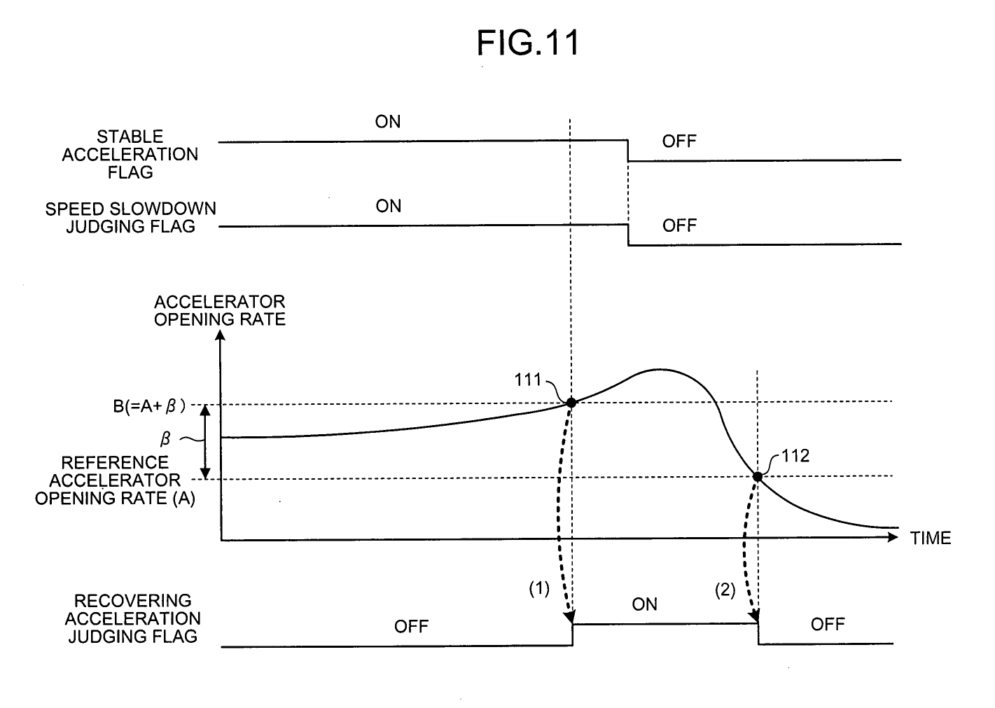

Another example in which the recovering acceleration judging flag is turned OFF is described below in greater detail with reference to FIG. 11. FIG. 11 is a schematic for explaining a second update timing of the recovering acceleration judging flag. The timing at which the recovering acceleration judging flag is turned ON in FIG. 11 (see (1) in FIG. 11) is similar to the timing at which the recovering acceleration judging flag is turned ON in FIG. 10.

As depicted in FIG. 11, the value obtained by adding the predetermined value (β) to the reference accelerator opening rate (A) is B. The recovering acceleration judging flag is turned ON (see (1) in FIG. 11) when the accelerator opening rate is increased to B (see 111 in FIG. 11). The recovering acceleration judging flag is turned OFF (see (2) in FIG. 11) when the accelerator opening rate increased to be larger than B is decreased to the reference accelerator opening rate (A) (see 112 in FIG. 11). The predetermined value (β) may be arbitrarily set.

Returning to the description of FIG. 2, the vehicle speed fluctuation detecting unit 11d is described below in greater detail. The vehicle speed fluctuation detecting unit 11d detects increase of the vehicle speed that meets a predetermined condition according to a signal value provided by the vehicle speed sensor 202 in the recovering acceleration area detected by the recovering acceleration area detecting unit 11c. The vehicle speed fluctuation detecting unit 11d also notifies the vehicle speed fluctuation number integrating unit 11e of the detection result thus obtained.

The vehicle speed fluctuation detecting processing performed by the vehicle speed fluctuation detecting unit 11d is described below in greater detail with reference to FIG. 12. FIG. 12 is a schematic for explaining the update timing of the vehicle speed fluctuation flag. As depicted in FIG. 12, the vehicle speed at the time when the recovering acceleration judging flag is turned ON (see 121 in FIG. 12) is stored in the driving evaluating apparatus 10 as the recovering acceleration reference vehicle speed B (see (1) in FIG. 12). The recovering acceleration reference vehicle speed B stored therein is cleared (deleted) (see (2) in FIG. 12) when the recovering acceleration judging flag is turned OFF.

The value obtained by adding the predetermined value (γ) to the recovering acceleration reference vehicle speed (B) is A. The vehicle speed fluctuation flag is turned ON when the vehicle speed is increased to A (see 122 in FIG. 12). When the vehicle speed fluctuation flag is turned ON, the vehicle speed fluctuation number integrating unit 11e increments the fluctuation number by one and clears the vehicle speed fluctuation flag (that is, turns the vehicle speed fluctuation OFF) (see (3) in FIG. 12).

Returning to the description of FIG. 2, the vehicle speed fluctuation number integrating unit 11e is described below in greater detail. The vehicle speed fluctuation number integrating unit 11e integrates the number of vehicle speed fluctuation detected by the vehicle speed fluctuation detecting unit 11d. The vehicle speed fluctuation number integrating unit 11e also notifies the accelerator operation judging unit 11f of the integration result.

The accelerator operation judging unit 11f judges whether the driving operation is appropriate according to the vehicle speed fluctuation number integrated by the vehicle speed fluctuation number integrating unit 11e. The accelerator operation judging unit 11f evaluates fuel-saving driving according to the vehicle speed fluctuation number, and then, notifies the informing processing unit 11g of the vehicle speed fluctuation number and the evaluation result thus obtained.

In the present embodiment, the accelerator operation judging unit 11f judges whether the driving operation is appropriate according to the vehicle speed fluctuation number obtained by the vehicle speed fluctuation number integrating unit 11e. The accelerator operation judging unit 11f may, however, judge whether the driving operation is appropriate according to the number of the vehicle speed slowdown areas detected by the vehicle speed slowdown area detecting unit 11b, the number of the recovering acceleration areas detected by the recovering acceleration area detecting unit 11c, and the like and then, the accelerator operation judging unit 11f may notify the informing processing unit 11g of the number of such areas as well as the evaluation result of the fuel-saving driving.

The informing processing unit 11g notifies the informing unit 12 of the vehicle speed fluctuation number and the evaluation result of fuel-saving driving notified by the accelerator operation judging unit 11f.

The informing unit 12 includes the meter 12a and the display 12b, and displays on the meter 12a or the display 12b the information notified by the control unit 11. The meter 12a displays the vehicle speed fluctuation number and ranking of the evaluation result by rotation of an indicator, for example. The display 12b displays a graphical display screen including the vehicle speed fluctuation number and the evaluation result, for example.

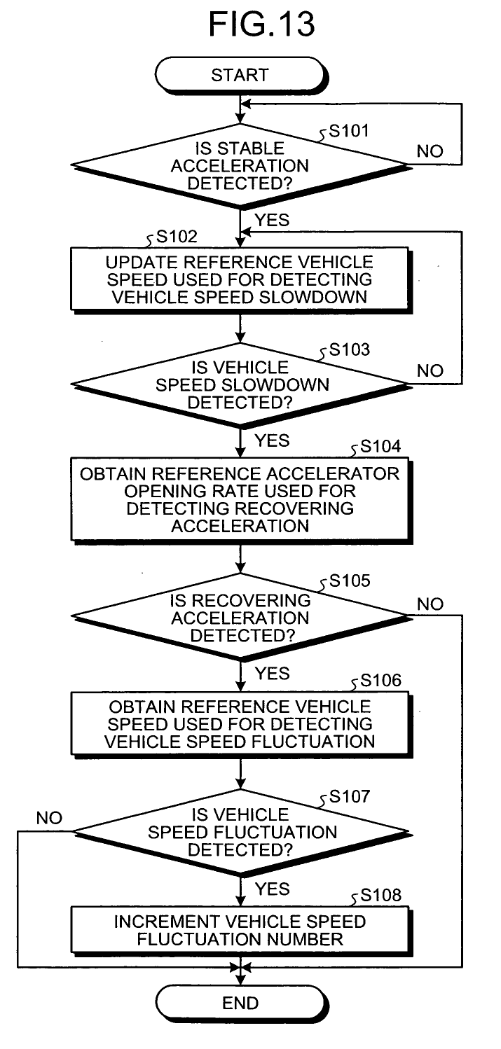

The processing procedures performed by the driving evaluating apparatus 10 in FIG. 2 are described below with reference to FIG. 13. FIG. 13 is a flowchart of the procedures performed by the driving evaluating apparatus 10. In FIG. 13, the procedures up to the processing in which the vehicle speed fluctuation number integrating unit 11e integrates the vehicle speed fluctuation numbers are explained.

As depicted in FIG. 13, the stable acceleration area detecting unit 11a judges whether the accelerator is stably pressed down (Step S101). If it is detected that the accelerator is stably pressed down (Yes at Step S101), the reference vehicle speed used for detecting a vehicle speed slowdown is updated (Step S102). If the judging condition of Step S101 is not met (No at Step S101), the procedure at Step S101 is repeated.

Then, the vehicle speed slowdown area detecting unit 11b judges whether a vehicle speed slowdown is detected (Step S103). If a vehicle speed slowdown is detected (Yes at Step S103), the reference accelerator opening rate used for detecting a recovering acceleration is obtained (Step S104). If the judging condition of Step S103 is not met (No at Step S103), the procedures at Step S102 and Step S103 are repeated.

Then, the recovering acceleration area detecting unit 11c judges whether an inappropriate recovering acceleration is detected (Step S105). If an inappropriate recovering acceleration is detected (Yes at Step S105), the reference vehicle speed used for detecting a vehicle speed fluctuation is obtained (Step S106). If the judging condition of Step S105 is not met (No at Step S105), the processing is terminated without performing the procedures after Step S105.

Then, the vehicle speed fluctuation detecting unit 11d judges whether a vehicle speed fluctuation caused by recovering acceleration is detected (Step S107). If a vehicle speed fluctuation is detected (Yes at Step S107), the vehicle speed fluctuation number integrating unit 11e increments the vehicle speed fluctuation number and terminates the processing (Step S108). If the judging condition of Step S107 is not met (No at Step S107), the processing is terminated without performing the processing thereafter.

As described above, in the driving evaluating apparatus according to the present embodiment, the acceleration stable area detecting unit detects the stable acceleration area that is the area in which the accelerator opening rate fluctuates within a predetermined range, the vehicle speed slowdown area detecting unit detects the vehicle speed slowdown area that is the area in which the vehicle speed is decreased according to the reference speed obtained by calculating based on the vehicle speed in the stable acceleration area detected by the stable acceleration area detecting unit and to the actual vehicle speed that represents the actual speed of the vehicle, the recovering acceleration area detecting unit detects the recovering acceleration area that is the area in which an excessive recovering acceleration is performed according to the reference accelerator opening rate corresponding to the start point of the vehicle speed slowdown area detected by the vehicle speed slowdown area detecting unit and to the actual accelerator opening rate that represents the actual value of the accelerator opening rate, and the accelerator operation judging unit judges whether the accelerator operation is appropriate according to the recovering acceleration area detected by the recovering acceleration area detecting unit.

Accordingly, the driving evaluating apparatus can be applied to various types of automobiles having different performances by using versatile data such as the accelerator opening rate and the vehicle speed. Further, driving can be evaluated quantitatively about ecological driving.

Although in the embodiment explained above, the driving evaluating apparatus mounted on a vehicle evaluates driving based on vehicle sensors (such as an accelerator opening rate sensor and a vehicle speed sensor), the driving may be evaluated by further using location information (arrangement information of roads, and buildings, for example) acquired from a car navigation device, a distance to the preceding vehicle obtained from a car-mounted radar device, and weather information. This enables driving evaluation with higher accuracy by reflecting driving conditions of a vehicle.

As has been explained above, the driving evaluating apparatus and the driving evaluation method according to the present invention are useful for evaluation about ecological driving, and in particular are suited for driving evaluation that can be widely used for various types of automobiles having different performances.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A driving evaluating apparatus that evaluates fuel-saving driving of a vehicle, the driving evaluating apparatus comprising:
a stable acceleration area detecting unit that detects a stable acceleration area that is an area in which an accelerator opening rate fluctuates within a predetermined range;
a vehicle speed slowdown area detecting unit that detects a vehicle speed slowdown area that is an area in which a vehicle speed is decreased according to a reference vehicle speed obtained by calculating based on the vehicle speed in the stable acceleration area detected by the stable acceleration area detecting unit and to an actual vehicle speed that represents an actual value of the vehicle speed;
a recovering acceleration area detecting unit that detects a recovering acceleration area that is an area in which a recovering acceleration is excessively performed according to a reference accelerator opening rate corresponding to a start point of the vehicle speed slowdown area detected by the vehicle speed slowdown area detecting unit and to an actual accelerator opening rate that represents an actual value of the accelerator opening rate; and
an accelerator operation judging unit that judges whether an accelerator operation is appropriate according to the recovering acceleration area detected by the recovering acceleration area detecting unit.

2. The driving evaluating apparatus according to claim 1, wherein a start point of the recovering acceleration area is detected when the vehicle speed slowdown area detecting unit detects the vehicle speed slowdown area in the stable acceleration area detected by the stable acceleration area detecting unit and when a value obtained by subtracting the reference accelerator opening rate from the actual accelerator opening rate is larger than a predetermined threshold.

3. The driving evaluating apparatus according to claim 2, wherein an end point of the recovering acceleration area is detected when the actual accelerator opening rate is smaller than the reference accelerator opening rate or when a predetermined period of time has passed since a value obtained by subtracting the reference accelerator opening rate from the actual accelerator opening rate became equal to or smaller than the predetermined threshold after the start point of the recovering acceleration area is detected.

4. The driving evaluating apparatus according to claim 1, wherein the vehicle speed slowdown area detecting unit detects the vehicle speed slowdown area when a value obtained by subtracting the actual vehicle speed from the reference vehicle speed is larger than a predetermined threshold.

5. The driving evaluating apparatus according to claim 1, further comprising a vehicle speed fluctuation detecting unit that detects a vehicle speed fluctuation caused by the recovering acceleration when a value obtained by subtracting the vehicle speed corresponding to the start point of the recovering acceleration area from the actual vehicle speed is larger than a predetermined threshold in the recovering acceleration area detected by the recovering acceleration area detecting unit, wherein the accelerator operation judging unit judges whether the accelerator operation is appropriate according to the vehicle speed fluctuation detected by the vehicle speed fluctuation detecting unit.

6. The driving evaluating apparatus according to claim 5, further comprising a vehicle speed fluctuation number integrating unit that integrates number of the vehicle speed fluctuation detected by the vehicle speed fluctuation detecting unit, wherein the accelerator operation judging unit judges whether the accelerator operation is appropriate according to the number of the vehicle speed fluctuation integrated by the vehicle speed fluctuation number integrating unit.

7. The driving evaluating apparatus according to claim 1, wherein the stable acceleration area detecting unit detects the stable acceleration area when a difference between a maximum accelerator opening rate that represents a maximum value of the accelerator opening rate in a predetermined period of time and a minimum accelerator opening rate that represents a minimum value of the accelerator opening rate in the predetermined period of time is smaller than a predetermined threshold.

8. The driving evaluating apparatus according to claim 1, wherein the stable acceleration area detecting unit first obtains, in chronological order, sets of the maximum accelerator opening rate that represents the maximum value of the accelerator opening rate in a predetermined period of time and the minimum accelerator opening rate that represents the minimum value of the accelerator opening rate in the predetermined period of time, and then detects the stable acceleration area when a difference between a maximum value of the maximum accelerator opening rate and a minimum value of the minimum accelerator opening rate in predetermined number of the sets of the maximum accelerator opening rates and the minimum accelerator opening rates most recently obtained is smaller than a predetermined threshold.

9. The driving evaluating apparatus according to claim 1, wherein the vehicle speed slowdown area detecting unit uses, as the reference vehicle speed, a maximum vehicle speed in the stable acceleration area.

10. A method for evaluating fuel-saving driving of a vehicle, comprising:
detecting a stable acceleration area that is an area in which an accelerator opening rate fluctuates within a predetermined range;
detecting a vehicle speed slowdown area that is an area in which a vehicle speed is decreased according to a reference vehicle speed obtained by calculating based on the vehicle speed in the detected stable acceleration area and to an actual vehicle speed that represents an actual value of the vehicle speed;
detecting a recovering acceleration area that is an area in which a recovering acceleration is excessively performed according to a reference accelerator opening rate corresponding to a start point of the detected vehicle speed slowdown area and to an actual accelerator opening rate that represents an actual value of the accelerator opening rate; and
judging whether an accelerator operation is appropriate according to the detected recovering acceleration area.

11. A computer readable storage medium containing instructions that, when executed by a computer, causes the computer to perform:
detecting a stable acceleration area that is an area in which an accelerator opening rate fluctuates within a predetermined range;
detecting a vehicle speed slowdown area that is an area in which a vehicle speed is decreased according to a reference vehicle speed obtained by calculating based on the vehicle speed in the detected stable acceleration area and to an actual vehicle speed that represents an actual value of the vehicle speed;
detecting a recovering acceleration area that is an area in which a recovering acceleration is excessively performed according to a reference accelerator opening rate corresponding to a start point of the detected vehicle speed slowdown area and to an actual accelerator opening rate that represents an actual value of the accelerator opening rate; and
judging whether an accelerator operation is appropriate according to the detected recovering acceleration area.
